(19) United States
(12) Patent Application Publication
(10) Pub. No.: US 2018/0024474 A1
(43) Pub. Date: Jan. 25, 2018

(54) IMAGE FORMING APPARATUS AND TRANSFER DEVICE

(71) Applicants: KABUSHIKI KAISHA TOSHIBA, Tokyo (JP); TOSHIBA TEC KABUSHIKI KAISHA, Tokyo (JP)

(72) Inventor: Sunao Takenaka, Odawara Kanagawa (JP)

(21) Appl. No.: 15/452,799

(22) Filed: Mar. 8, 2017

(30) Foreign Application Priority Data
Jul. 19, 2016 (JP) 2016-141892

(51) Int. Cl. G03G 15/16

(52) U.S. Cl. CPC G03G 15/1665

(57) ABSTRACT

An image forming apparatus comprises a toner image forming section; a transfer section configured to transfer the toner image formed by the toner image forming section onto a medium; a power supply section configured to supply a voltage of either a constant current or a constant voltage to the transfer section; a state detection section configured to detect a state of the toner image formed by the toner image forming section; a resistance detection section configured to apply a constant current or voltage to the transfer section to detect a resistance value of the transfer section; and a control section configured to determine which one of a constant current system and a constant voltage system a system of the transfer bias is set to on the basis of a detection result of the state detection section and a detection result of the resistance detection section.

### CROSS-REFERENCE TO RELATED APPLICATIONS

This application is based upon and claims the benefit of priority from Japanese Patent Application No. 2016-141892, filed Jul. 19, 2016, the entire contents of which are incorporated herein by reference.

### FIELD

Embodiments described herein relate generally to an image forming apparatus, a transfer device, and method related thereto.

### BACKGROUND

Conventionally, there is an image forming apparatus such as a Multi-Function Peripheral (hereinafter, referred to as an “MFP”) and a printer. The image forming apparatus applies a bias voltage to a transfer section including a transfer roller and a belt to cause a desired current to flow to the transfer section and transfers a toner image onto a sheet from the transfer section. The current flowing to the transfer section is restricted by electric resistance of the transfer roller and electric resistance of the sheet. Values of the electric resistance of the transfer roller and the electric resistance of the sheet are influenced by environment and thus are subject to change and/or fluctuation. In a technology (constant voltage system) for applying a constant bias voltage to the transfer section, if the value of the foregoing electric resistance fluctuates, the flow of the desired current is difficult to maintain, and as a result there are instances in which a proper transfer image is not obtained.

By contrast, a technology for applying different methods respectively to state detection of the transfer section and state detection of the sheet to determine the bias voltage to be applied to the transfer section is known. For example, in the state of the transfer section, before image transfer to the sheet is started, it is measured by energizing a known current to the transfer section to detect a voltage. In the state of the sheet, it is presumed on the basis of environment information obtained from temperature and humidity sensors.

Through the foregoing combination, a bias voltage for achieving a desired current is determined by presuming a partial voltage applied to the transfer section and the sheet. The foregoing technology is excellent for correcting variations of the electric resistance of the transfer section due to environmental changes; however, there are times when variations of electric resistance of the sheet cannot be fully corrected. When the electric resistance of the sheet fluctuates beyond a range presumed on the basis of the environmental information or a result of an experiment, there are times when an image defect is generated. For example, if the sheet is preserved for a long time in a dry environment, moisture in the sheet evaporates, and the electric resistance of the sheet becomes higher than expected. The tendency is different according to the type of the sheet. It is difficult to detect the generation of such conditions from the environment information obtained from the temperature and humidity sensors.

By contrast, a technology (constant current system) for causing a desired current to flow from a constant current transformer to the transfer section is known. Under a high humidity environment, the electric resistance of the transfer roller and the electric resistance of the sheet are reduced. In the constant current system, as the current value is restricted, in the case of the high humidity environment, there is a problem that the distribution of the current contributing to transfer of toner is biased and the transfer becomes insufficient due to the reduction of the electric resistance of the transfer roller. As stated above, it is not easy to guarantee print quality without being influenced by the change of the environment.

### DESCRIPTION OF THE DRAWINGS

FIG. 1 is a diagram illustrating the constitution of an image forming apparatus 1 according to an embodiment;

FIG. 2 is a diagram schematically illustrating an example of the constitution of the image forming apparatus 1;

FIG. 3 is a flowchart illustrating the summary of an example of transfer control;

FIG. 4 is a diagram illustrating a developing contrast potential;

FIG. 5 is a diagram illustrating a relationship between a developing contrast potential Vc for developing a predetermined amount of toner and a toner charge amount Qm;

FIG. 6 is a flowchart illustrating an example of a processing for presuming a developing electric field; and

FIG. 7 is a diagram illustrating a determination condition of a resistance value to the toner charge amount.

### DETAILED DESCRIPTION

In accordance with an embodiment, an image forming apparatus comprises a toner image forming section, a transfer section, a power supply section, a state detection section, a resistance detection section and a control section. The toner image forming section forms a toner image. The transfer section transfers the toner image formed by the toner image forming section onto a medium. The power supply section supplies a voltage of either a constant current or a constant voltage to the transfer section. The state detection section detects a state of the toner image formed by the toner image forming section. The resistance detection section applies the voltage supplied from the power supply section to the transfer section to detect a resistance value of the transfer section. The control section determines which one of a constant current system and a constant voltage system a system of the transfer bias is set to on the basis of a detection result of the state detection section and a detection result of the resistance detection section.

In the image forming apparatus of the embodiment, it is possible to guarantee print quality without being influenced by change of an environment. Hereinafter, the image forming apparatus of the embodiment is described in detail. Further, the same reference numerals are applied to the same constitutions having identical or similar functions in the following description. Then, there is a case in which descriptions of these constitutions are omitted.

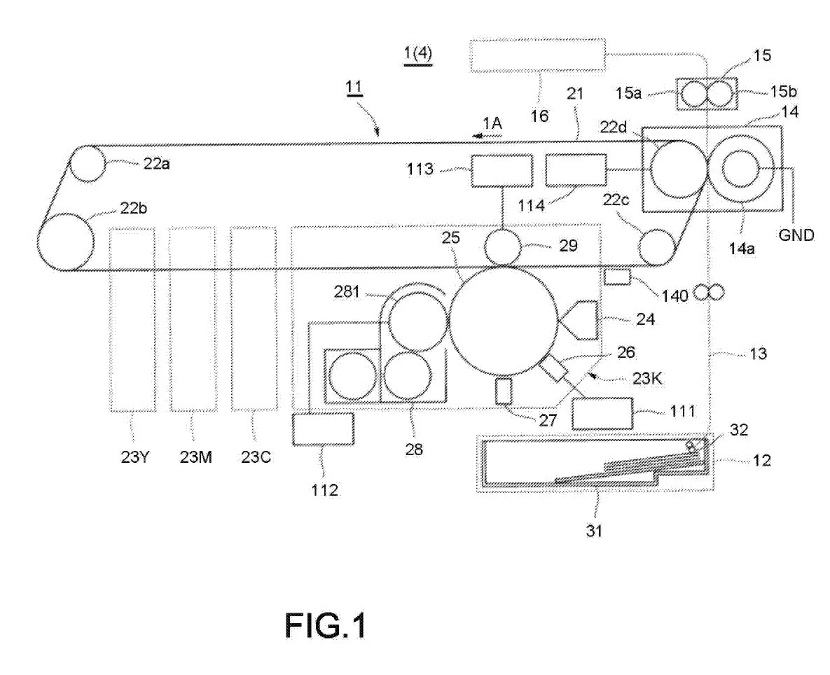

FIG. 1 is a diagram illustrating the constitution of an image forming apparatus 1 according to the embodiment. The image forming apparatus 1 is, for example, an electrophotographic type MFP (Multi-Function Peripheral).

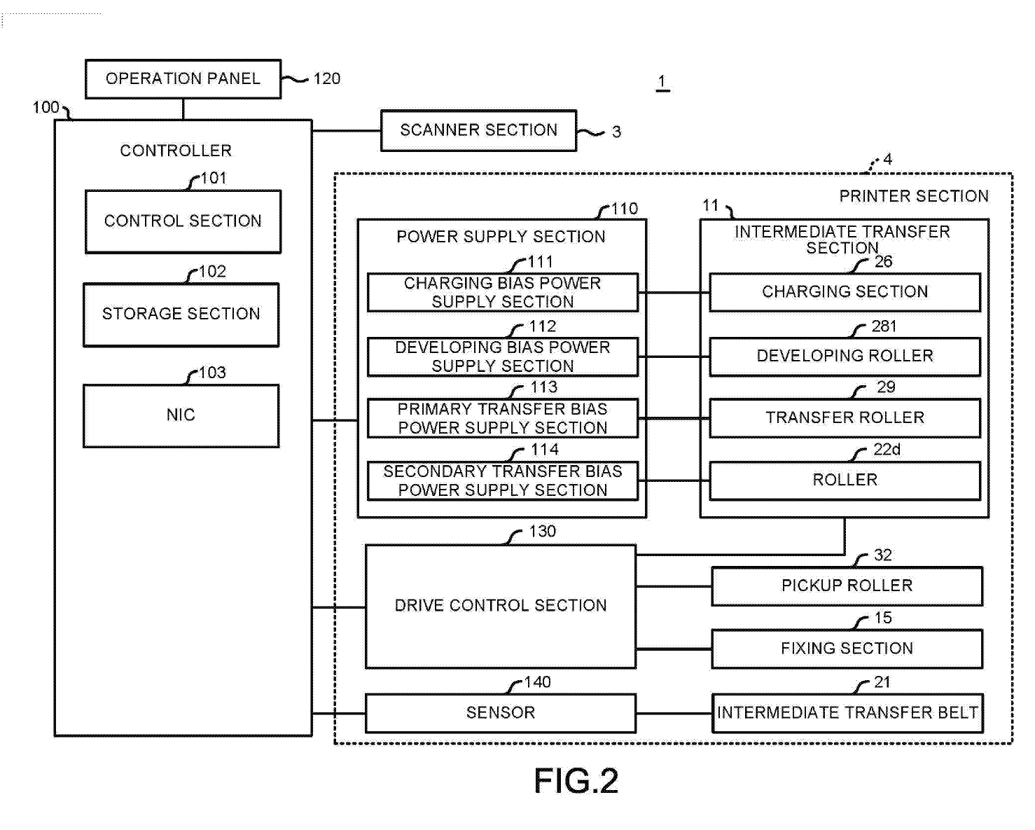

Firstly, the summary of the image forming apparatus 1 is described. The image forming apparatus 1 includes a scanner section 3 (FIG. 2) and a printer section 4. The scanner section 3 reads image information of a document as digital data. The printer section 4 forms an image on a sheet on the basis of image data. The printer section 4 forms the image with a recording agent. For example, the recording agent is toner. The printer section 4 is an example of a transfer device.

Next, the printer section 4 is described in detail. The printer section 4 includes an intermediate transfer section 11, a sheet feed section 12, a conveyance path 13, a secondary transfer section 14, a fixing section 15 and a sheet discharge section 16.

The intermediate transfer section (primary transfer section) 11 includes an intermediate transfer belt 21, a plurality of rollers 22a, 22b, 22c and 22d and a plurality of image forming sections 23Y, 23M, 23C and 23K. The intermediate transfer belt 21 is formed in an endless shape. The plurality of the rollers 22a, 22b, 22c and 22d supports the intermediate transfer belt 21. In this way, the intermediate transfer belt 21 can travel endlessly in a direction indicated by an arrow 1A in FIG. 1.

The plurality of the image forming sections (process units) 23Y, 23M, 23C and 23K includes a yellow image forming section 23Y, a magenta image forming section 23M, a cyan image forming section 23C and a black image forming section 23K. The image forming sections 23Y, 23M, 23C and 23K are mutually arranged in parallel in the horizontal direction. As stated above, characters Y, M, C and K attached to signs of the respective constitutions mean yellow, magenta, cyan and black, respectively.

Each of the image forming sections 23Y, 23M, 23C and 23K includes a cleaner 24, a photoconductive drum 25, a charging section 26, an exposure section 27, a developing section 28 and a transfer roller 29. The constitutions of the image forming sections 23Y, 23M, 23C and 23K are the same as each other except that the colors of the recording agents thereof are different. Further, in the following description, the signs of Y, M, C, and K are omitted, and the detailed constitution of each of the image forming sections 23Y, 23M and 23C is not shown.

The cleaner 24 removes the recording agent adhering to the surface of the photoconductive drum 25. The photoconductive drum 25 has a surface on which the image is formed with the recording agent. The surface of the photoconductive drum 25 on which the recording agent is removed by the cleaner 24 rotates around an axis in a predetermined direction. The rotation direction of the photoconductive drum 25 is a direction in which the part of the surface of the photoconductive drum 25 at which the recording agent is removed approaches the charging section 26, the exposure section 27, the developing section 28 and the transfer roller 29 in order. The charging section (charging charger) 26 charges the surface of the photoconductive drum 25. The exposure section (exposure scanning unit) 27, for example, irradiates the surface of the photoconductive drum 25 with laser light of which intensity is adjusted to expose the surface of the photoconductive drum 25. In this way, an electrostatic latent image based on the image data is formed on the surface of the photoconductive drum 25. The developing section 28 can house the recording agent corresponding to each color. The developing section 28 includes a developing roller 281. The developing roller 281 is arranged to be close to the housing section of the recording agent and the photoconductive drum 25. The developing roller 281 rotates around an axis and adsorbs the recording agent on the surface thereof, and then supplies the recording agent to the surface of the photoconductive drum 25. In this way, the recording agent adheres to the electrostatic latent image part formed on the surface of the photoconductive drum 25. The transfer roller 29 faces the intermediate transfer belt 21 from an opposite side to the photoconductive drum 25. In this way, the recording agent is transferred (primarily transferred) from the surface of the photoconductive drum 25 to the intermediate transfer belt 21. Furthermore, as shown in FIG. 1, in the image forming section 23, the charging section 26 and the developing section 28 are arranged under the photoconductive drum 25.

Next, the sheet feed section 12, the conveyance path 13, the secondary transfer section 14, the fixing section 15 and the sheet discharge section 16 are described.

The sheet feed section 12 includes a sheet feed cassette 31.

The sheet feed cassette 31 is formed in a bowl shape, of which the upper part is opened. The sheet feed cassette 31 can house a plurality of sheets P on which the image is printed. The sheet feed cassette 31 is mounted in a housing (not shown). The housing is not arranged to shield inflow of open air. The sheet P housed in the sheet feed cassette 31 is influenced by an environment outside the housing, and moisture absorption of the sheet P is changed.

For example, a pickup roller 32 is arranged in the sheet feed cassette 31. The pickup roller 32 sends the sheet P housed in the sheet feed cassette 31 to the conveyance path 13. The conveyance path 13 is a path from the sheet feed section 12 to the sheet discharge section 16 via the secondary transfer section 14 and the fixing section 15. The sheet P is conveyed in the conveyance path 13.

The secondary transfer section 14 includes a transfer roller 14a. The transfer roller 14a comes in contact with the outside of the intermediate transfer belt 21. One roller 22d that supports the intermediate transfer belt 21 is included in components of the secondary transfer section 14. The roller 22d is opposite to the transfer roller 14a across the intermediate transfer belt 21. The sheet P together with the intermediate transfer belt 21 is sandwiched between the transfer roller 14a and the roller 22d. In this way, the recording agent on the intermediate transfer belt 21 is transferred (secondarily transferred) onto the surface of the sheet P. The sheet P passing through the secondary transfer section 14 is sent towards the fixing section 15. The transfer roller 14a (secondary transfer body) and the intermediate transfer belt 21 (intermediate transfer body) are examples of the transfer section. According to this point of view, the transfer section includes the intermediate transfer belt 21 onto which the toner image is primarily transferred and the transfer roller 14a for transferring the toner image from the intermediate transfer belt 21 onto the sheet P.

The fixing section 15 includes a heat roller 15a and a press roller 15b. The heat roller 15a is controlled to a fixing temperature (printing temperature) suitable to the fixing of the recording agent. The press roller 15b faces the sheet P from the opposite side to the heat roller 15a. The sheet P onto which the recording agent is transferred is sandwiched by the heat roller 15a and the press roller 15b. In this way, the sheet P is heated and pressed between the heat roller 15a and the press roller 15b. In this way, the recording agent transferred onto the sheet P is fixed on the sheet P.

The sheet discharge section 16 discharges the sheet P passing through the fixing section 15. Furthermore, in the following description, the recording agent is described as toner.

FIG. 2 is a diagram schematically illustrating an example of the constitution of the image forming apparatus 1.

The image forming apparatus 1 includes a controller 100, a power supply section 110, an operation panel 120, a drive control section 130 and a sensor 140.

The controller 100 includes a control section 101, a storage section 102 and a NIC (Network Interface Card) 103. The control section 101 is an arithmetic processing apparatus. The control section 101 carries out programs stored in the storage section 102 to control each section of the image forming apparatus 1 to print desired information on the sheet P. The storage section 102 includes a volatile storage device and a nonvolatile storage device. The volatile storage device includes a RAM (Random Access Memory). The nonvolatile storage device includes a ROM (Read Only Memory), an HDD (Hard Disk Drive) or an SSD (Solid State Drive). The storage section 102 stores programs of processing carried out by the control section 101 and data such as constants used for the processing, a table and a pattern for adjustment. The foregoing constant includes a standard value applied to an initial value of the processing and the like. The NIC 103 controls communication with an external device.

The operation panel 120 includes a keyboard and a touch panel display. The operation panel 120 receives an instruction from a user. The operation panel 120 displays control contents.

The drive control section 130 adjusts a drive amount of each drive section in the image forming apparatus 1. For example, control objects of the drive control section 130 include drive sections such as each roller in the intermediate transfer section 11, the pickup roller 32, and the roller of the fixing section 15.

The sensor 140 detects a density of an image of a pattern for adjustment TP formed on the surface of the intermediate transfer belt 21 with, for example, a photodiode (not shown). The density of the image detected by the sensor 140 is determined, and an adhesion amount of the toner is automatically adjusted. Details of an adjustment processing of the adhesion amount of the toner are described later.

The power supply section 110 supplies a desired bias through the control of the control section 101. The power supply section 110 includes a charging bias power supply section 111, a developing bias power supply section 112, a primary transfer bias power supply section 113 and a secondary transfer bias power supply section 114.

The charging bias power supply section 111 supplies a charging bias Vg1 to the charging section 26 to uniformly charge the surface of the photoconductive drum 25.

The developing bias power supply section 112 supplies a developing bias Vb1 to the developing roller 281 of the developing section 28.

The primary transfer bias power supply section 113 supplies a bias Vt1 to the transfer roller 29. The primary transfer bias power supply section 113 varies a voltage of the bias Vt1 according to the control by the control section 101 to adjust a transfer bias.

The secondary transfer bias power supply section 114 supplies a bias Vt2 to the roller 22d. The secondary transfer bias power supply section 114 includes a constant voltage source and a constant current source. The secondary transfer bias power supply section 114 can select whether to supply the bias Vt2 by the constant voltage system or the constant current system through the control of the control section 101. In a case in which the bias Vt2 is supplied by the constant voltage system, a voltage value is designated from the control section 101, and the secondary transfer bias power supply section 114 supplies the bias Vt2 having the designated voltage value. In a case in which the bias Vt2 is supplied by the constant current system, a current value is designated from the control section 101, and the secondary transfer bias power supply section 114 supplies the bias Vt2 having the designated current value. As stated above, the secondary transfer bias power supply section 114 varies the voltage or the current of the bias Vt2 through the control of the control section 101 to adjust the transfer bias.

Next, transfer control is described. The control section 101 carries out the following transfer control.

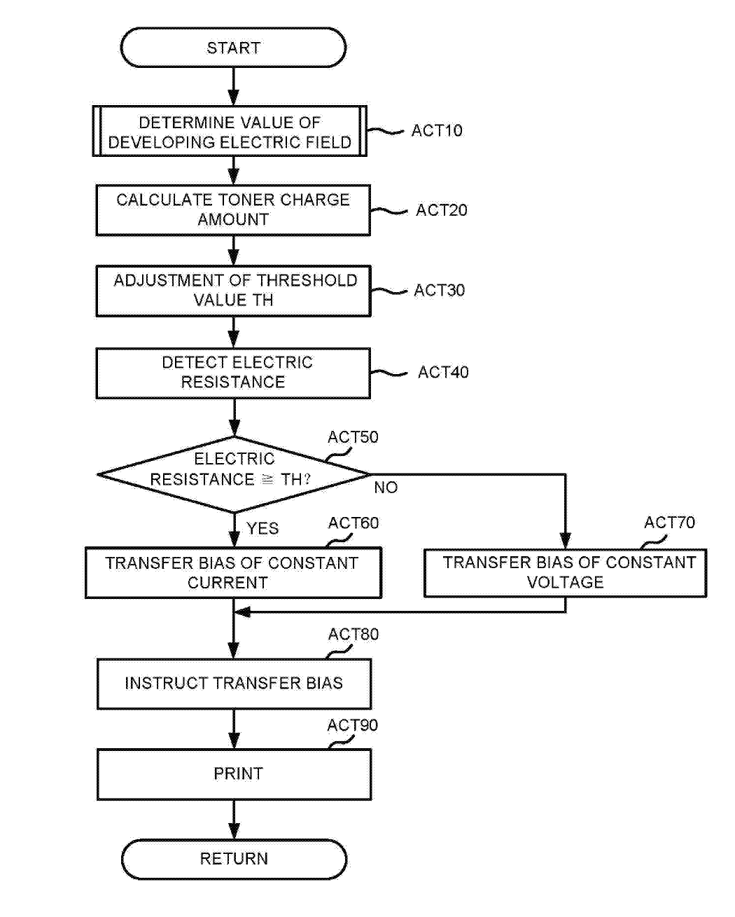

FIG. 3 is a flowchart illustrating the summary of an example of the transfer control.

Firstly, the control section 101 detects easiness of the developing of the toner according to the following procedures.

The control section 101 sets a secondary transfer system of the secondary transfer section 14 to a constant voltage control system as a basic system. The control section 101 transfers the image for the pattern for adjustment TP onto, for example, the intermediate transfer belt 21 from the photoconductive drum 25. The sensor 140 detects the image transferred onto the intermediate transfer belt 21. The control section 101 presumes a developing electric field required for the developing on the basis of a pattern density detected by the sensor 140 (ACT 10). The developing electric field refers to an electric field needed to move the charged toner from the developing roller 281 to the photoconductive drum 25. For example, in a case in which an absolute value of the developing electric field is relatively large, the control section 101 indirectly identifies that the toner is in a state in which the toner is difficult to move. In the actual control by the control section 101, as the developing electric field, a developing contrast potential Vc (described later) serving as a difference between a developing bias potential and a surface potential of the photoconductor after exposure is used.

The control section 101 derives a toner charge amount Qm on the basis of the developing electric field presumed in the processing in ACT 10 (ACT 20). The toner charge amount Qm refers to a charge amount Q charged to toner per unit weight M of toner. For example, in a case in which the value of the developing electric field obtained in the processing in ACT 10 is relatively large, the control section 101 determines that an absolute value of the toner charge amount Qm is large and the toner is difficult to move.

The control section 101 adjusts a threshold value TH for determining the secondary transfer system on the basis of the toner charge amount Qm (ACT 30). For example, the control section 101 determines the threshold value TH of resistance detection for moving the secondary transfer system to the constant current control system according to the toner charge amount Qm presumed in the processing in ACT 20. For example, in a case in which the absolute value of the toner charge amount Qm is relatively small, the control section 101 increases the value of the foregoing threshold value TH.

The control section 101 detects electric resistance of the secondary transfer section 14 (ACT 40). For example, the control section 101 controls the secondary transfer bias power supply section 114 to cause a constant current for measurement to flow to the secondary transfer section 14 including the transfer roller 14a and the intermediate transfer belt 21. For example, the constant current for measurement is different from the current of the transfer bias. The control section 101 derives a resistance value of the electric resistance of the secondary transfer section 14 on the basis of the voltage generated in the transfer roller 14a and the intermediate transfer belt 21 through the flow of the foregoing constant current. Details of the detection of the electric resistance of the secondary transfer section 14 are described later.

The control section 101 determines whether or not the electric resistance of the secondary transfer section 14 is equal to or greater than the threshold value TH (ACT 50).

If the electric resistance of the secondary transfer section 14 is equal to or greater than the threshold value TH (YES in ACT 50), the control section 101 selects the constant current system. The control section 101 determines the constant current having a predetermined current value as the transfer bias (ACT 60), and then proceeds to a processing in ACT 80. If the electric resistance of the secondary transfer section 14 is smaller than the threshold value TH (NO in ACT 50), the control section 101 selects the constant voltage system. The control section 101 determines the constant voltage having a predetermined voltage value as the transfer bias (ACT 70), and then proceeds to a processing in ACT 80.

After the processing in ACT 60 or ACT 70 is ended, the control section 101 instructs the transfer bias determined in the processing in ACT 60 or ACT 70 for the secondary transfer bias power supply section 114 (ACT 80). The control section 101 uses the transfer bias instructed in the processing in ACT 80 to carry out printing (ACT 90).

According to the foregoing procedures, the control section 101 carries out the transfer control. As stated above, the control section 101 adjusts the transfer bias depending on the toner charge amount Qm.

Detailed examples of the processing of all the stages described above are described in order.

(1. Description of Toner Adhesion Amount Control by the Developing Contrast Potential)

(1-1. Derivation of the Developing Contrast Potential Corresponding to the Developing Electric Field)

The developing contrast potential is defined as an amount corresponding to the developing electric field in the actual control, and the adhesion amount of the toner to be developed is adjusted by controlling the amount.

FIG. 4 is a diagram illustrating the developing contrast potential. In FIG. 4, the vertical axis indicates the voltage. The potential of the photoconductive drum 25 charged by the charging bias Vg1 to the photoconductive drum 25 is indicated by a charging potential V01. The potential applied to the developing roller 281 is indicated by the developing bias potential Vb1. The surface potential of the photoconductive drum 25 after the exposure is indicated by an exposure potential Ve1.

For example, a case in which the charging potential V01 of the photoconductive drum 25 is −500 volt, the developing bias potential Vb1 is −400 volt, and the exposure potential Ve1 is −80 volt is exemplified and described.

A potential difference between the developing bias potential Vb1 and the exposure potential Ve1 is referred to as the developing contrast potential Vc. The developing contrast potential Vc is represented by the difference between the developing bias potential Vb1 and the exposure potential Ve1, and in the foregoing case, is 320 volt. In a case in which the numerical value exemplified above is set to a standard value and each potential is adjusted according to various conditions such as the type of the sheet P and the environment, the developing contrast potential Vc is within a range of about 300-350 volt. In the present embodiment, in a case in which the charging potential is lower than the developing bias potential Vb1 as negative charge toner is used (for example, in a case in which the charging potential is V01), the toner is not moved from the developing roller 281 to the photoconductive drum 25. In a case in which the charging potential is higher than the developing bias potential Vb1 (for example, in a case in which the charging potential is Ve1), the toner is moved from the developing roller 281 to the photoconductive drum 25. The larger the developing contrast potential Vc is at the minus side, the larger a movement amount of the toner is.

The control section 101 uses the developing contrast potential Vc determined on the basis of the toner adhesion amount control by the sensor 140 in the transfer control.

(1-2. Relationship between the Developing Contrast Potential and the Toner Charge Amount Qm and Presumption of the Toner Charge Amount)

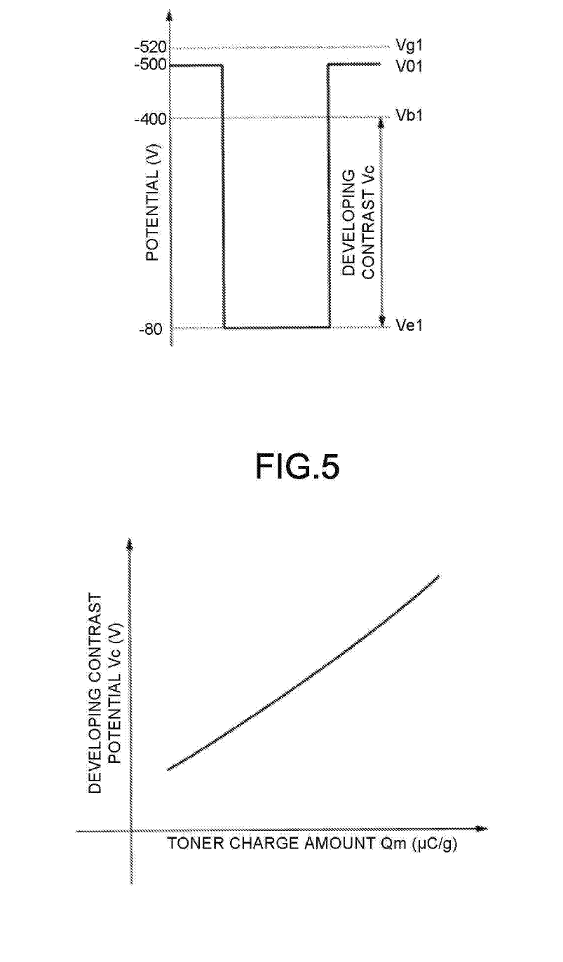

FIG. 5 is a diagram illustrating the relationship between the developing contrast potential Vc for developing a predetermined amount of toner and the toner charge amount Qm. As shown in FIG. 5, the relationship between the developing contrast potential Vc and the toner charge amount Qm is as follows: the larger the absolute value |Qm| of the toner charge amount Qm (hereinafter, simply referred to as the toner charge amount Qm) is, the more the absolute value of the developing contrast potential Vc (hereinafter, simply referred to as the developing contrast potential Vc) required for the developing is increased. The toner charge amount Qm is monotonically increased according to the increase in the developing contrast potential Vc. In other words, as the toner charge amount Qm becomes large, adhesion force of the toner to the developing agent carrier on the developing roller 281 becomes stronger, and the toner is difficult to move from the developing roller 281 side to the photoconductive drum 25. Thus, the control section 101 increases the developing contrast potential Vc as the toner charge amount Qm becomes large.

The control section 101 presumes the toner charge amount Qm using the relationship in FIG. 5 from the developing contrast potential Vc determined on the basis of the toner adhesion amount control. The toner adhesion amount control refers to control for adjusting the adhesion amount of the toner so that the pattern for adjustment TP is printed and a desired density is achieved. For example, the sensor 140 detects the state of the developed pattern for adjustment TP on the intermediate transfer belt 21. The control section 101 adjusts the developing contrast potential Vc so that the adhesion amount of the toner on the intermediate transfer belt 21 becomes almost constant according to a detection value of the sensor 140.

Furthermore, there are times when the exposure potential Ve1 is called a surface potential of the photoconductor after exposure. The control section 101 derives the surface potential of the photoconductor after exposure from a revolution speed of the photoconductive drum 25, the temperature of the photoconductive drum 25 and laser power used for the exposure. For example, a relationship of the surface potential of the photoconductor after exposure, the revolution speed of the photoconductive drum 25, the temperature and the laser power are determined in advance. Information indicating the correspondence relationship may be tabled and stored in the storage section 102.

(1-3. Procedures of the Adjustment of the Developing Contrast Potential Based on the Detected Pattern Density)

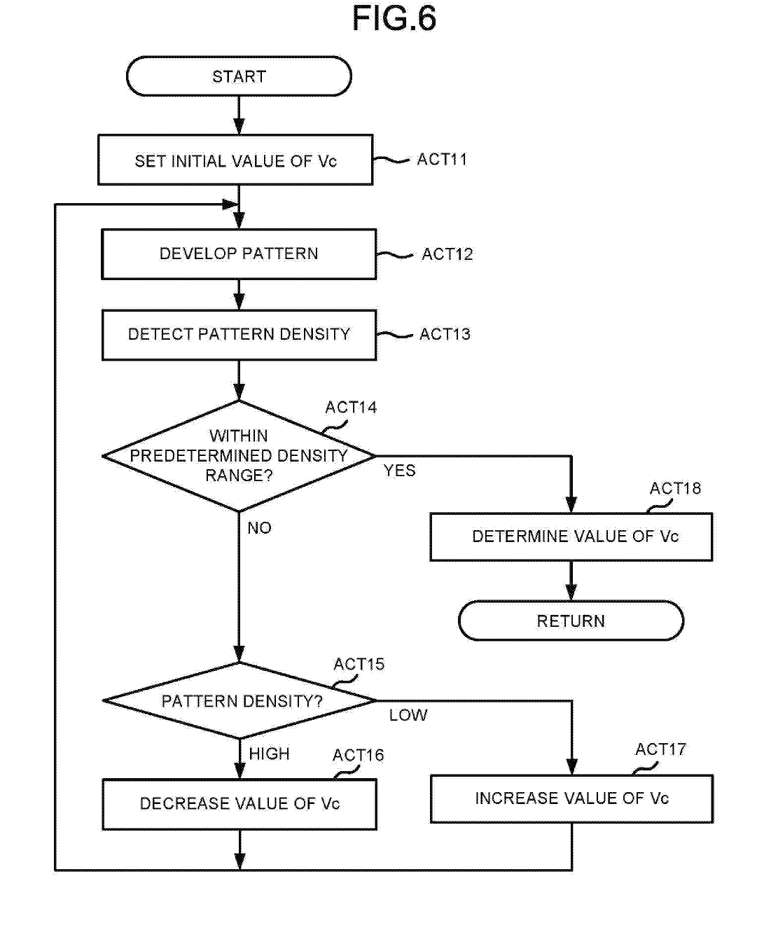

The control section 101, for example, carries out the adjustment of the developing electric field based on the detected pattern density through the following procedures. FIG. 6 is a flowchart illustrating an example of a processing for presuming the developing electric field.

Firstly, the control section 101 sets a preset standard value as an initial value of the developing contrast potential Vc (ACT 11). For example, the foregoing standard value is stored in the storage section 102.

Next, the control section 101 develops the predetermined pattern for adjustment TP at the set value of the developing contrast potential Vc (ACT 12).

Next, the control section 101 detects the pattern density of the surface of the intermediate transfer belt 21 with the sensor 140 (ACT 13).

Next, the control section 101 determines whether or not the pattern density detected by the sensor 140 is within a predetermined density range on the basis of a threshold value of the density range (ACT 14).

If the pattern density is out of the predetermined density range (NO in ACT 14), the control section 101 determines the density on the basis of the threshold value of the density range (ACT 15).

If the density is higher than the threshold value of the density range through the determination in ACT 15, the control section 101 decreases the developing contrast potential Vc by a predetermined amount (ACT 16), and proceeds to a processing in ACT 12.

If the density is lower than the threshold value of the density range through the determination in ACT 15, the control section 101 increases the developing contrast potential Vc by a predetermined amount (ACT 17), and proceeds to a processing in ACT 12.

If the pattern density is within the predetermined density range (YES in ACT 14), the control section 101 determines that the value of the developing contrast potential Vc is proper to determine the developing contrast potential Vc (ACT 18), and then ends a series of processing.

In this way, the control section 101 adjusts the developing contrast potential Vc so that the adhesion amount of the toner of the surface of the intermediate transfer belt 21 becomes almost constant without being influenced by the environment and the like.

In the above, the control section 101 repeatedly increases or decreases the developing contrast potential Vc to carry out the printing so that the pattern density is within the predetermined range. At this time, the control section 101 adjusts at least either the potential of the charging bias Vg or the potential of the developing bias Vb1 to adjust the developing contrast potential Vc. The control section 101 adjusts the foregoing developing contrast potential Vc so that the detected pattern density falls within a density target range. With the completion of the foregoing adjustment, the adhesion amount of the toner to the photoconductive drum 25 and the intermediate transfer belt 21 becomes a proper amount.

(2. Adjustment of a Condition for Switching the System of the Transfer Bias)

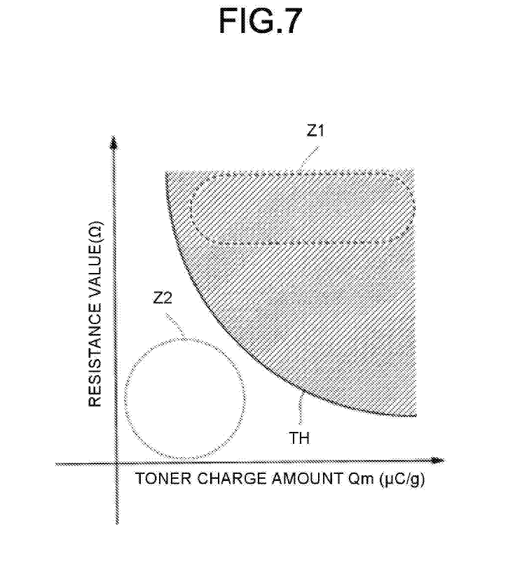

FIG. 7 is a diagram illustrating a determination condition of a secondary transfer roller resistance value to a toner charge amount. FIG. 7 is a graph illustrating the secondary transfer roller resistance value (Ω (ohm)) (vertical axis) to the toner charge amount Qm (μC/g (microcoulomb/gram)) (horizontal axis). The toner charge amount Qm is the charge amount Q charged to the toner per unit weight M of toner.

A curve TH shown in FIG. 7 is a threshold value for switching the system of the transfer bias. The control section 101 selects the transfer bias of the constant current system in an area in which the resistance value is identical to or higher than the curve TH, or selects the transfer bias of the constant voltage system in an area in which the resistance value is lower than the curve TH.

In the curve TH shown in FIG. 7, as the toner charge amount Qm is increased, the value corresponding to the resistance value is monotonously decreased. In other words, the higher the toner charge amount Qm is, the smaller the value corresponding to the resistance value becomes. Furthermore, the curve TH is curved in a convex shape downwards. The smaller the toner charge amount Qm is, the larger the change of the value corresponding to the resistance value becomes.

For example, the curve TH may be formularized through a formula

TH=(A*Qm^{B})/L (1)

In the formula (1), A is a positive real number and B is a negative real number. Examples of A and B serving as constants are shown in formulas (2) and (3).

A=2.05*10¹¹ (2)

B=−0.875 (3)

Further, in the foregoing formula (1), L is a length (mm) in an extending direction of the roller, that is, in an axial direction. The roller may be, for example, any one of the roller 22d, the photoconductive drum 25 and the transfer roller 29. Alternatively, L may be the width of the intermediate transfer belt 21 instead of the length in the extending direction of the roller.

The foregoing formula (1) takes the length L in the extending direction of the roller as a variable in addition to satisfying the tendency as the foregoing curve TH. In other words, the longer the length L in the extending direction of the roller is, the smaller the value of the threshold value TH becomes.

Even if the rollers have the same outer diameter and the same material, the resistance value is changed if the length L in the extending direction (image width direction) is changed. It is necessary to change the threshold value TH according to the length L of the roller. The foregoing formula (1) easily corresponds to a case of including the length L of the roller as the variable in the formula to constitute the length in the extending direction of the roller instead of different lengths.

(3. Detection and Determination of the Electric Resistance of the Secondary Transfer Section 14)

The control section 101 determines an application system of a bias to the secondary transfer section 14 on the basis of the electric resistance of the secondary transfer section 14 (for example, a range including the transfer roller 14a and the intermediate transfer belt 21).

In a case in which the electric resistance of the secondary transfer section 14 is relatively high, even if transferring a toner image with the transfer bias of the constant current system, the secondary transfer section 14 is difficult to be influenced by a print width and can transfer a toner image having a narrow print width. This is because the current flowing to a non-image part is suppressed by the electric resistance of the secondary transfer section 14.

Thus, the control section 101 determines an application system of a bias to the secondary transfer section 14 on the basis of the threshold value determined as stated above. For example, the control section 101 sets the application system of the bias to the secondary transfer section 14 to the constant voltage system as a fundamental. Furthermore, the control section 101 sets the application method of the bias to the secondary transfer section 14 to the constant current system in a case in which the value of the electric resistance of the secondary transfer section 14 is equal to or greater than some threshold value.

A dry state such as winter season and a wet state such as a summer season are exemplified, and control under different environment states is described with reference to FIG. 7.

In a case in which air is in the dry state, moisture in the sheet P is evaporated if the sheet P is preserved for a long time, and there is a tendency that the electric resistance of the sheet P and the electric resistance of the secondary transfer roller 14a become high. The dry state progresses after the toner is opened, and with the progress, there is a tendency that the toner charge amount Qm becomes high. There are times when the value of the toner charge amount Qm is changed independent of the dry state of the environment according to a condition with respect to the foregoing basic tendency. In other words, in a case in which air is in the dry state, an event is varied within the range of Z1.

As stated above, in a case in which air is in the dry state, it is desired to select the constant current control. The range of Z1 shown in FIG. 7 falls within a range in which the resistance value is higher than the curve TH. According to the determination condition, the control section 101 can select the constant current system for each event that is varied within the range of Z1.

In a case in which air is in the wet state, there is a tendency that the electric resistance of the sheet P and the electric resistance of the secondary transfer roller 14a or the intermediate transfer belt 21 become low. The toner charge amount Qm becomes less as the moisture is high. In other words, in a case in which air is in the wet state, an event is varied within the range of Z2.

As stated above, in a case in which air is in the wet state, it is desired to select the constant voltage system. The range of Z2 shown in FIG. 7 falls within a range in which the resistance value is lower than the curve TH. According to the determination condition, the control section 101 can select the constant voltage system for each event that is varied within the range of Z2.

The ranges of Z1 and Z2 shown in FIG. 7 may be different depending on a combination of the type, the thickness, the material and ingredients of the sheet P. The control section 101 determines the ranges of Z1 and Z2 according to the foregoing combination. The control section 101 may adjust the values of the constants of the foregoing formulas (2) and (3) on the basis of the range determined as described above.

In the present embodiment, the transfer bias of either the constant current or the constant voltage is applied to the intermediate transfer belt 21, and the secondary transfer section 14 transfers the image formed with the toner on the intermediate transfer belt 21 onto the sheet P. The power supply section 110 generates the transfer bias applied to the secondary transfer section 14. The control section 101 adjusts the threshold value TH of the determination for determining which one of the constant current system and the constant voltage system the system of transfer bias is set to on the basis of the detection result of the toner adhering to the intermediate transfer belt 21. The control section 101 determines the system of transfer bias on the basis of the threshold value TH and an index value to be changed corresponding to the electric resistance of the secondary transfer section 14. In this way, the image forming apparatus 1 can guarantee the print quality without being influenced by the change of the environment. Furthermore, the foregoing electric resistance of the secondary transfer section 14 includes the electric resistance of a part or all of the transfer roller 14a, the intermediate transfer belt 21 and the roller 22d.

The control section 101 adjusts the threshold value TH on the basis of the toner charge amount Qm derived on the basis of the detection result of the toner adhering to the intermediate transfer belt 21. In this way, the influence caused by the fluctuation of the toner charge amount Qm can be reduced.

The control section 101 derives the toner charge amount Qm on the basis of the detection result of the toner adhering to the intermediate transfer belt 21. The control section 101 adjusts the threshold value TH on the basis of the derived toner charge amount Qm and the length in the extending direction of the transfer roller 14a.

The control section 101 controls the secondary transfer bias power supply section 114 to cause the constant current to flow to the secondary transfer section 14. The control section 101 derives a resistance value of the electric resistance of the secondary transfer section 14 on the basis of the voltage generated by causing the constant current to flow to the secondary transfer section 14. In a case in which the foregoing resistance value of the electric resistance is equal to or greater than the threshold value TH determined as the determination condition, the control section 101 sets the system of the bias to the constant current system. In a case in which the foregoing resistance value is smaller than the threshold value TH, the control section 101 sets the system of the bias to the constant voltage system. In this way, the influence of the change of the resistance value of the electric resistance due to the change of the environment is reduced by determining the foregoing resistance value of the electric resistance with reference to the threshold value TH based on the foregoing resistance value of the electric resistance. The constant current at the time of the derivation of the foregoing resistance value of the electric resistance of the secondary transfer section 14 may take a different current value from the constant current set as the bias at the time of the transfer. Alternatively, the constant current at the time of the derivation of the foregoing resistance value of the electric resistance of the secondary transfer section 14 may be set to a representative value which is determined from a fluctuation range of the constant current set as the bias. Further, the control section 101 may derive a resistance value of the electric resistance of the secondary transfer section 14 on the basis of the flowing current by applying the constant voltage to the secondary transfer section 14 instead of the above.

The control section 101 controls the adhesion amount of the toner on the basis of the detection result from the sensor for detecting the toner adhering to the intermediate transfer belt 21. The control section 101 detects the developing electric field (developing contrast potential Vc) needed to develop a predetermined adhesion amount of the toner through the toner adhesion amount control. The control section 101 can also derive the threshold value TH as the determination condition corresponding to the value of the detected developing electric field (developing contrast potential Vc) with the relationship in FIG. 5 and the relationship in FIG. 7. According to the derivation, the control section 101 adjusts the threshold value TH on the basis of the developing electric field (developing contrast potential Vc) required for the adhesion of a predetermined toner amount. The control section 101 reduces the influence of the change of the developing electric field (developing contrast potential Vc), and guarantees the print quality.

The control section 101 presumes the toner charge amount corresponding to the value of the detected developing electric field (developing contrast potential Vc), and includes the toner charge amount as the variable to derive the threshold value. The control section 101 reduces the influence of the change of the toner charge amount, and guarantees the print quality.

The control section 101 sets restriction by the electric resistance of the secondary transfer section 14 in the determination for determining which one of the constant current system and the constant voltage system is selected as the system of the bias. In this way, under the dry environment such as winter, if the dry condition is a source of the variation condition, the constant current system can be selected, and the transfer to the sheet P is stably carried out. Further, according to the foregoing embodiment, the constant voltage system can be selected under a high humidity environment.

The control section 101 stabilizes the threshold value in the determination for determining the system of the bias, and in this way, the management of the value becomes easy. By including the length in the extending direction of the transfer roller 14a as the variable in the foregoing formula, application to a machine having a narrow print width becomes easy, and frequency at which insufficiency of transfer in that case can occur can be reduced.

The control section 101 sets the threshold value TH relatively highly in a case in which the toner charge amount Qm is relatively low, and thus it is difficult to select the constant current system. The control section 101 sets the threshold value TH relatively lowly in a case in which the toner charge amount Qm is relatively high, and thus it is easy to select the constant current system. The toner charge amount Qm is low and the resistance of the transfer roller 14a is low under the high humidity environment . The control section 101 can suppress the selection of the constant current system under the high humidity environment by setting such a threshold value TH described above.

Further, before an image transfer of a regular document is started, the control section 101 uses a result of the adjustment with the pattern for adjustment TP to carry out the image transfer of the regular document. In a case in which a plurality of sheets P of the same type housed in the housing section 31 is printed, the control section 101 may not carry out the adjustment with the pattern for adjustment TP until the printing condition is changed.

The sensor 140 may detect the density of the image of the pattern for adjustment TP formed on the surface of the photoconductive drum 25.

The foregoing description of the embodiment is a case applied to the secondary transfer by the secondary transfer section 14; however, the same technique may be applied to the primary transfer from the photoconductive drum 25 to the intermediate transfer belt 21.

According to the embodiment described above, the image forming apparatus 1 includes the image forming section 23, the secondary transfer section 14, the power supply section 110, the sensor 140, the resistance detection section and the control section 101. The image forming section 23 forms a toner image. The secondary transfer section 14 transfers the toner image formed by the image forming section 23 onto a sheet P. The power supply section 110 supplies a transfer bias voltage of either a constant current or a constant voltage to the secondary transfer section. The sensor 140 detects a stage of the toner image formed by the image forming section 23. The resistance detection section applies a constant current or voltage to the secondary transfer section 14 to detect a resistance value of the secondary transfer section 14. The control section 101 determines which one of a constant current system and a constant voltage system a system of the transfer bias is set to on the basis of a detection result of the sensor 140 and a detection result of the resistance detection section. In this way, the image forming apparatus 1 can guarantee the print quality without being influenced by the change of the environment. Furthermore, the foregoing electric resistance of the secondary transfer section 14 includes the electric resistance of a part or all of the transfer roller 14a, the intermediate transfer belt 21 and the roller 22d. The secondary transfer bias power supply section 114 and the control section 101 are examples of the foregoing resistance detection section.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a toner image forming section configured to form a toner image;
a transfer section configured to transfer the toner image formed by the toner image forming section onto a medium;
a power supply section configured to supply a transfer bias voltage of either a constant current or a constant voltage to the transfer section;
a state detector configured to detect a state of the toner image formed by the toner image forming section;
a resistance detector configured to detect a resistance value of the transfer section by applying a constant current or voltage to the transfer section ; and
a control section configured to determine which system of a constant current system and a constant voltage system to use for supplying the transfer bias voltage on the basis of a detection result of the state detector and a detection result of the resistance detector.

2. The image forming apparatus according to claim 1, wherein
the transfer section comprises an intermediate transfer body onto which the toner image is transferred and a secondary transfer body for transferring the toner image from the intermediate transfer body onto the medium; and
the control section is further configured to adjust the determination on the basis of a charge amount of the toner derived on the basis of the detection result of the state detector.

3. The image forming apparatus according to claim 2, wherein
the control section derives a charge amount of the toner on the basis of the detection result of the state detector and adjusts a determination condition for determining which system to use for supplying the transfer bias voltage to the secondary transfer body on the basis of the charge amount of the toner and a length in an extending direction of the secondary transfer body.

4. The image forming apparatus according to claim 1, wherein
the control section derives a resistance value of the electric resistance on the basis of a voltage generated in the transfer section by causing a constant current different from the transfer bias to flow to the transfer section; sets the system of the transfer bias to the constant current system when the resistance value of the electric resistance is equal to or greater than a threshold value determined as the determination condition; and sets the system of the transfer bias to the constant voltage system when the resistance value is smaller than the threshold value.

5. The image forming apparatus according to claim 1, wherein
the control section is further configured to repeatedly increase or decrease a developing contrast potential so that a pattern printing density is within a predetermined range.

6. The image forming apparatus according to claim 1, wherein
the control section is further configured to adjust the determination on the basis of a charge amount of the toner derived on the basis of the detection result of the state detector.

7. The image forming apparatus according to claim 6, wherein
the control section derives a charge amount of the toner on the basis of the detection result of the state detector and adjusts a determination condition for determining which system to use for supplying the transfer bias voltage on the basis of the charge amount of the toner and a length in an extending direction of the transfer section.

8. The image forming apparatus according to claim 1 is a multi-function peripheral.

9. A transfer device, comprising:
a transfer section configured to transfer a toner image onto a medium;
a power supply section configured to supply a transfer bias voltage of either a constant current or a constant voltage to the transfer section; and
a control section configured to adjust a determination condition of determination for determining which system of a constant current system and a constant voltage system to use for supplying the transfer bias voltage on the basis of a detection result of a state of the toner image formed by the toner image forming section, and further configured to determine the system of the transfer bias voltage on the basis of an index value to be changed corresponding to electric resistance of the transfer section and the determination condition.

10. The transfer device according to claim 9, wherein
the transfer section comprises an intermediate transfer body onto which the toner image is transferred and a secondary transfer body for transferring the toner image from the intermediate transfer body onto the medium; and
the control section is further configured to adjust the determination on the basis of a charge amount of the toner derived on the basis of the detection result.

11. The transfer device according to claim 10, wherein
the control section derives a charge amount of the toner on the basis of the detection result and adjusts a determination condition for determining which system to use for supplying the transfer bias voltage to the secondary transfer body on the basis of the charge amount of the toner and a length in an extending direction of the secondary transfer body.

12. The transfer device according to claim 9, wherein
the control section derives a resistance value of the electric resistance on the basis of a voltage generated in the transfer section by causing a constant current different from the transfer bias to flow to the transfer section; sets the system of the transfer bias to the constant current system when the resistance value of the electric resistance is equal to or greater than a threshold value determined as the determination condition; and sets the system of the transfer bias to the constant voltage system when the resistance value is smaller than the threshold value.

13. The transfer device according to claim 9, wherein
the control section is further configured to adjust the determination on the basis of a charge amount of the toner derived on the basis of the detection result.

14. The transfer device according to claim 13, wherein
the control section derives a charge amount of the toner on the basis of the detection result and adjusts a determination condition for determining which system to use for supplying the transfer bias voltage on the basis of the charge amount of the toner and a length in an extending direction of the transfer section.

15. An image forming apparatus comprising the transfer device according to claim 9.

16. An image forming method, comprising:
forming a toner image;
transferring the toner image onto a medium;
supplying a transfer bias voltage of either a constant current or a constant voltage to a transferring section;
detecting a state of forming the toner image;
applying a constant current or voltage to the transferring section to detect a resistance value of the transferring section; and
determining which system of a constant current system and a constant voltage system to use for supplying the transfer bias voltage on the basis of a detection result of detecting the state of forming the toner image and a detection result of applying a constant current or voltage to the transferring section.

17. The image forming method according to claim 16, wherein
the transferring section comprises an intermediate transfer body onto which the toner image is transferred and a secondary transfer body for transferring the toner image from the intermediate transfer body onto the medium,
the method further comprising:
adjusting the determination on the basis of a charge amount of the toner derived on the basis of the detection result of detecting the state of forming the toner image.

18. The image forming method according to claim 17, further comprising:
deriving a charge amount of the toner on the basis of detecting the state of forming the toner image and adjusting a determination condition for determining which system to use for supplying the transfer bias voltage to the secondary transfer body on the basis of the charge amount of the toner and a length in an extending direction of the secondary transfer body.

19. The image forming method according to claim 16, further comprising:
deriving a resistance value of the electric resistance on the basis of a voltage generated in the transferring section by causing a constant current different from the transfer bias to flow to the transferring section;
setting the system of the transfer bias to the constant current system when the resistance value of the electric resistance is equal to or greater than a threshold value determined as the determination condition; and
setting the system of the transfer bias to the constant voltage system when the resistance value is smaller than the threshold value.

20. The image forming method according to claim 16, further comprising:
repeatedly increasing or decreasing a developing contrast potential so that a pattern printing density is within a predetermined range.
